(19) United States
(12) Patent Application Publication
(10) Pub. No.: US 2009/0251822 A1
(43) Pub. Date: Oct. 8, 2009

(54) MAGNETIC RECORDING MEDIUM AND MAGNETIC RECORDING APPARATUS

(75) Inventor: Hironori Teguri, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/483,762

(22) Filed: Jun. 12, 2009

Related U.S. Application Data
(63) Continuation of application No. PCT/JP2006/325499, filed on Dec. 21, 2006.

(51) Int. Cl. G11B 5/187

(52) U.S. Cl. 360/122; G9B/5.051

(57) ABSTRACT

A magnetic recording medium includes a plurality of recording tracks formed of a magnetic material and a non-magnetic area arranged between the recording tracks to separate each recording track. The non-magnetic area is formed of a non-magnetic material, which can accumulate and retain electric charges. The electric charges accumulated in the non-magnetic area represent servo information.

### CROSS-REFERENCE TO RELATED APPLICATIONS

This application is a U.S. continuation application, filed under 35 USC 111(a) and claiming the benefit under 35 USC 120 and 365(c), of PCT application JP/2006/325499 filed Dec. 21, 2006. The foregoing application is hereby incorporated herein by reference.

### FIELD

The embodiment discussed herein is directed to a magnetic recording medium and a magnetic recording apparatus using a magnetic recording medium.

### BACKGROUND

In order to attain a high recording density in a magnetic disk apparatus to realize a large-capacity recording, a discrete track medium (DTM) appears promising. A discrete track medium is a recording medium in which a groove is formed between recording tracks in a recording layer formed of a magnetic material and a dielectric material is filled in this portion to provide a non-magnetic area to separate the recording tracks.

Positioning of a magnetic head to a recording medium in a magnetic recording apparatus using the DTM is carried out according to a servo control, and it is suggested to apply a sector servo method as is in a conventional one.

However, the DTM is different from a conventional medium in that a magnetic head must follow a recording track, which is previously formed physically on the medium. That is, it is an issue in a case using the DTM that a magnetic head must accurately follow a recording track between servo sectors in which servo information is recorded. In order to do so, it is suggested to acquire information for track-following between servo sectors before shipment of a magnetic recording medium and record the information as servo information in a servo sector. In this method, an area for recording the servo information is needed on the recording medium, which reduces a user data area (format capacity) for storing user data, and this is an issue to be solved for a magnetic recording apparatus using the DTM.

Patent Document 1 suggests a method of using a recording medium in which a track is separated by grooves (pit lines) and the grooves are filled by a dielectric material, and detecting a capacitance of the groove portion to use in a servo control. However, writing servo information on the recording medium is not disclosed in Patent Document 1, and a seek technique for controlling a movement of a magnetic head to a designated track is also not explained.

On the other hand, there is suggested a technique to record information by applying an electric charge to a dielectric material. Non-Patent Document 1 discloses a technique to apply and retain an electric charge locally on a dielectric film. Additionally, Non-Patent Document 2 discloses a technique in which electric charges are applied to a dielectric material to form a memory and information is read by reading electric charges.

Additionally, Patent Document 2 discloses a technique to perform recording by applying a voltage to a dielectric material recording medium from a probe in order to apply an electric charge as a dot.

Patent Document 1: Japanese Laid-Open Patent Application No. 7-210863

Patent Document 2: Japanese Laid-Open Patent Application No. 2003-296979

Non-Patent Document 1: R. C. Barrett and C. F. Quate, “Charge storage in a nitride-oxide-silicon medium by scanning capacitance microscopy”, J.Appl.Phys., vol. 70, and 2725 (1991)

Non-Patent Document 2: SOICHI IWAMURA, YASUAKI NISHIDA, and KAZUHIKO HASHIMOTO, “Rotating MNOS Disk Memory Device”, IEEE Trans.ED., vol. 28, and 854 (1981)

As mentioned above, in the magnetic recording apparatus using a conventional discrete track medium, recording servo information, which is used for causing a magnetic head to follow accurately a recording track, on the recording medium cannot be performed without using a user data area of the recording medium. Accordingly, the user data recording area is reduced by an area for recording servo information, and, as a result, there is a problem in that a formatting efficiency is low.

The present invention is made in view of the above-mentioned problem, and it is an object to provide a magnetic recording medium as a discrete track medium on which servo information is written in an area between tracks, and a magnetic recording apparatus using such a magnetic recording medium.

### SUMMARY

In order to achieve the above-mentioned object, there is provide according to one aspect of the present invention a magnetic recording medium comprising: a plurality of recording tracks formed of a magnetic material; and a non-magnetic area arranged between the recording tracks to separate each recording track, wherein the non-magnetic area is formed of a non-magnetic material, which accumulates and retains electric charges.

There is provided according to another aspect of the present invention a magnetic recording apparatus comprising: the above-mentioned magnetic recording medium; and a magnetic head configured to perform magnetic recording on the recording tracks, wherein the magnetic head has a conductive probe that detects the electric charges accumulated in the non-magnetic area of the magnetic recording medium.

The object and advantages of the embodiment will be realized and attained by means of the elements and combinations particularly pointed out in the appended claims.

It is to be understood that both the foregoing general description and the following detailed description are exemplary explanatory only and are not restrictive of the invention, as claimed.

### BRIEF DESCRIPTION OF DRAWINGS

FIG. 1 is a plan view illustrating a magnetic disk configured as a discrete track medium;

FIG. 2 is a cross-sectional view of the magnetic disk illustrated in FIG. 1 taken along a line II-II of FIG. 1;

FIG. 3 is an illustration illustrating an example of an arrangement of electric charges accumulated in a non-magnetic area of the magnetic disk;

FIG. 4 is an illustration of an arrangement of accumulated electric charges in a bit-patterned medium;

FIG. 5 is a perspective view of a magnetic disk apparatus, which is a magnetic recording apparatus according to an embodiment of the present invention;

FIG. 6 is a cross-sectional view of a magnetic disk and a magnetic head floating above the magnetic disk;

FIG. 7 is a block diagram of a head control part provided in the magnetic disk apparatus;

FIG. 8 is a waveform chart of a capacitance detection signal; and

FIG. 9 is an illustration for explaining a positional relationship between a position at which a conductive probe passes and an electric charge.

### DESCRIPTION OF EMBODIMENT(S)

Preferred embodiment of the present invention will be explained with reference to the accompanying drawings.

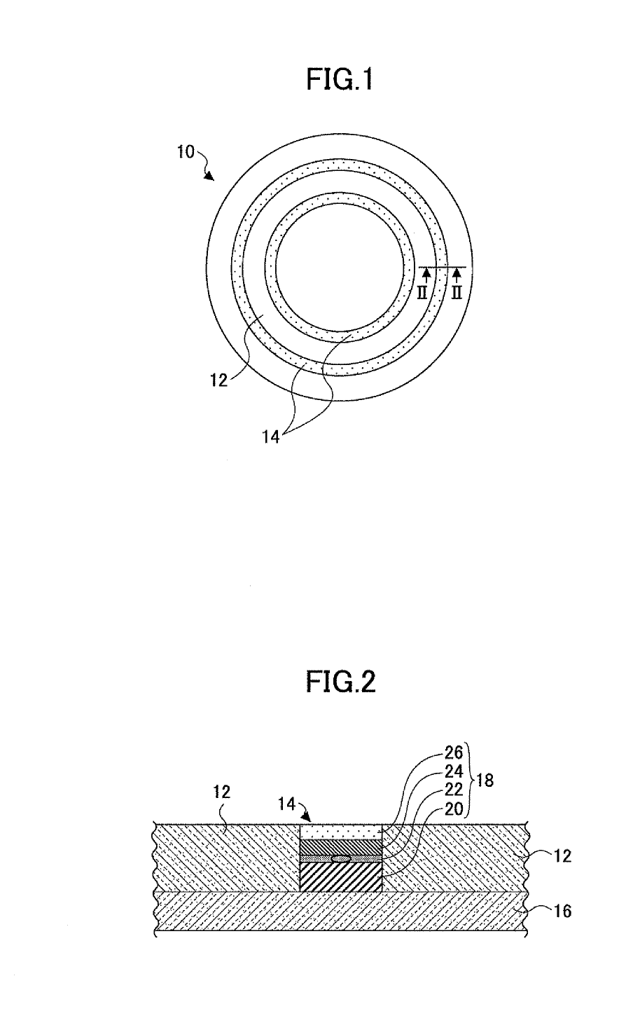

First, a description will be given of a magnetic recording medium to which the present invention is applied. FIG. 1 is a plan view illustrating a magnetic disk configured as a discrete track medium.

The magnetic disk 10 illustrated in FIG. 1 is a discrete track medium (hereinafter, may be referred to as DTM), and includes track parts 12 formed of a magnetic material and non-magnetic areas 14 formed of a non-magnetic material. Although only one track part is illustrated in FIG. 1, the width of the track part 12 is, for example, 100 to 200 nm, and, actually, a large number of the track parts 12 are formed concentrically, each of which is separated by the non-magnetic area 14 arranged therebetween. The width of the non-magnetic area 14 is 20 to 70% of the width of the track part 12. It should be noted that the track parts 12 may not be formed in a concentric form but also formed in a spiral form.

FIG. 2 is a cross-sectional view of the magnetic disk 10 taken along a line II-II in FIG. 1. The magnetic disk 10 has a structure in which the above-mentioned track parts 12 and a lamination 18 constituting the above-mentioned non-magnetic areas 14 are formed on a substrate 16 formed by an electrically conductive material such as aluminum (Al).

The track part 12 is formed of a magnetic material such as, for example, an alloy containing cobalt (Co), chrome (Cr) and platinum (Pt). Information is recorded according to an arrangement of magnetic dots formed by locally magnetizing the track part 12 using a magnetic head.

The lamination 18, which constitutes the non-magnetic area 14 formed between the adjacent track parts 12, is formed of a non-magnetic material in order to magnetically separate each track part 12. The lamination 18 includes a silicon layer 20 formed on the substrate 16, a silicon oxide film formed on the silicon layer 20, a silicon nitride film 24 formed on the silicon oxide film 22, and a metal layer 26 formed on the silicon nitride film 26. The metal layer 26 is formed by an electrically conductive metal such as, for example, aluminum (Al), copper (Cu), gold (Au), etc.

The thickness of the lamination 18 is substantially equal to the thickness of the track parts 12. That is, the surface of the metal layer 26 is in the same plane as the surface of the track parts 12 so that the surface of the magnetic disk 10 is a flat surface. Thereby, the magnetic head can move smoothly above the surface of the magnetic disk 10.

It is known that the laminating structure of the lamination 18 has a characteristic that, when an electric field is applied locally from an external part, an electric charge is accumulated at a portion where the electric field is applied, which results in that an electric charge is accumulated and retained locally in the silicon nitride film 24. In the present embodiment, the substrate 16 made of a metal such as aluminum and the metal layer 26 act as opposing electrodes, and the silicon oxide film 22 and the silicon nitride film 24 are arranged as a dielectric material between the electrodes. In such a structure, if the substrate 16 is caused to be at a ground potential and a voltage is applied to a portion of the metal layer 26, an electric field is generated at the portion where the voltage is applied, and, due to the electric field, an electric charge is accumulated at an interface between the silicon oxide film 22 and the silicone nitride film 24, which are dielectric materials, which results in formation of an electric charge dot. According to an amount of the electric charge accumulated, an expansion of a depletion layer created between the silicon layer 20 and the silicon oxide layer 22 changes. Because the change in the depletion layer causes a change in the capacitance, the electric charge dot can be read using a conductive probe and a capacitance detection circuit.

It is known that a ferroelectric material such as a lithium tantalum oxide (LiTaO₃) has the accumulation and retaining action of the electric charge in the above-mentioned lamination 18. Therefore, such a ferroelectric material may be used instead of the above-mentioned lamination 18.

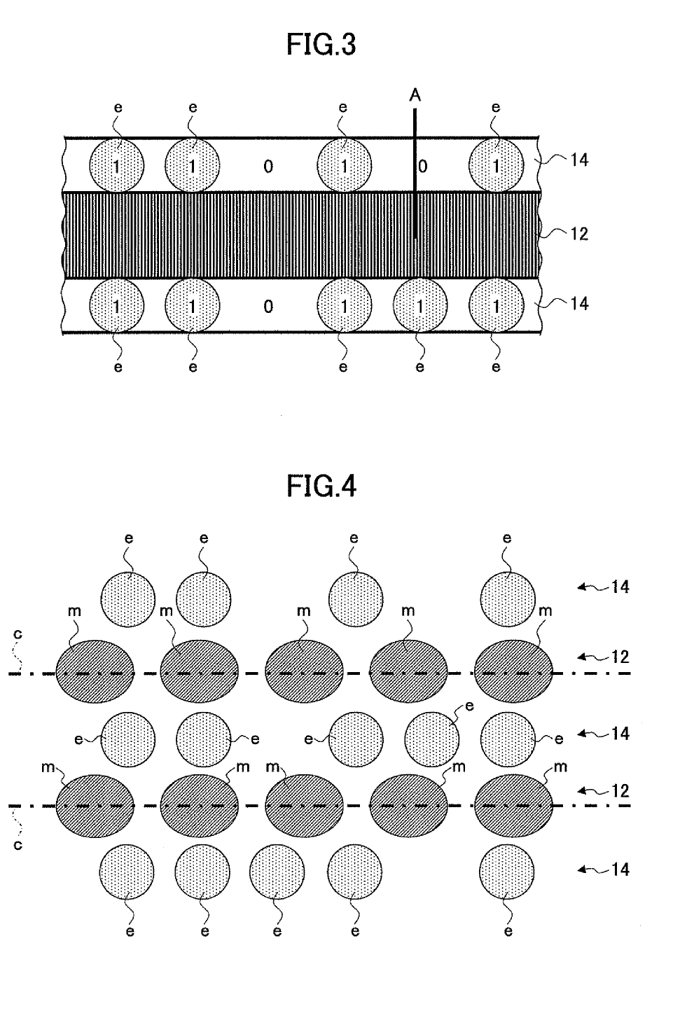

FIG. 3 is an illustration illustrating an example of an arrangement of electric charges accumulated in the non-magnetic area 14 as mentioned above. In FIG. 3, a surface of the track part 12 is illustrated, and the non-magnetic areas 14 (the surface of the metal layer 26) are illustrated on both sides thereof. The track part 12 is a recording track on which information is magnetically recorded by a magnetic head.

In the non-magnetic area 14, dot-like electric charges e are accumulated and retained by applying a voltage locally as mentioned above. Servo information can be recorded by arranging the dot-like electric charges e in an extending direction of the non-magnetic areas 14. In the example shown in FIG. 3, track number information is recorded as servo information in the non-magnetic area 14. The track number information can be read by detecting the dot-like electric charges e along the non-magnetic area 14. For example, if a portion where the dot-like electric charge e is accumulated is set to “1” and a portion where the dot-like electric charge e is not accumulated is set to “0”, information such as a numerical value can be recorded digitally by a sequence of “1” and “0”. In the example illustrated in FIG. 3, the information recorded in the upper non-magnetic area 14 is “110101”, which is track number information of the recording track under the upper non-magnetic area 14. Moreover, information recorded in the lower non-magnetic area 14 is “110111”, which is the track number information of the recording track (not illustrated in the figure) under the lower non-magnetic area 14.

FIG. 4 is an illustration illustrating an arrangement of the accumulated electric charges e in a bit-patterned medium. In the case of the bit-patterned medium, magnetic dots m are formed in alignment along a center line c of the recording track, and the dot-like electric charges e are arranged beside the row of the magnetic dots m.

As mentioned above, because the magnetic disk 10, which is the magnetic recording medium according to the present embodiment, includes the non-magnetic area 14 as an area for separating the track parts 12 and servo information can be recorded in the non-magnetic area, the servo information can be recorded on the magnetic disk 10 easily without using the track parts 12, which are user data areas. The servo information is previously recorded before shipment of the magnetic disk 10. The recorded servo information can be easily reproduced by reading the electric charges retained in the non-magnetic area 14 by a magnetic disk reproducing apparatus, which enables easy acquisition of the servo information used when magnetically recording user data on the track parts 12. Thus, there is no need to record the servo information in the user data area. Therefore, the user data area can be used efficiently, which improves a formatting efficiency and an amount of information (a disk capacity) recordable on a single sheet of the magnetic disk 10 can be increased.

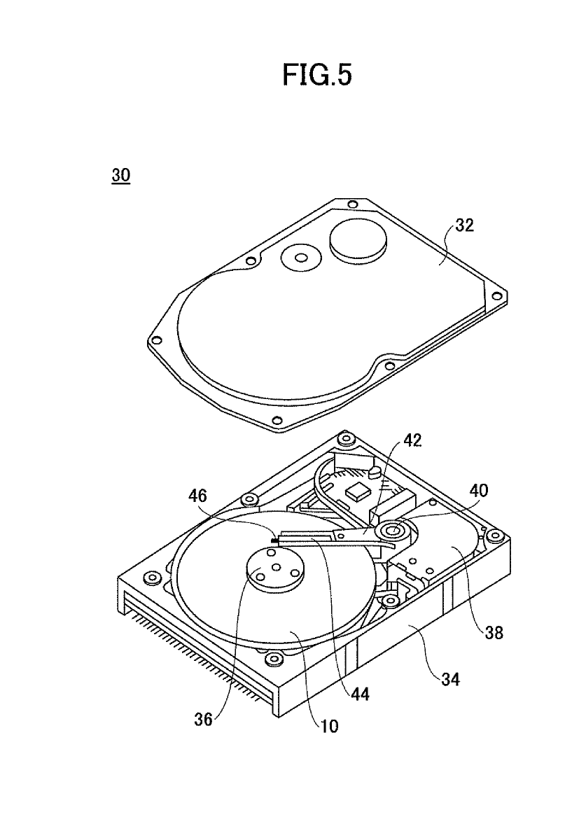

Next, a description will be given of a magnetic disk apparatus, which is a magnetic recording apparatus according to an embodiment of the present invention. FIG. 5 is a perspective view of a magnetic disk apparatus 30, which is a magnetic recording apparatus according to an embodiment of the present invention. Illustrated in FIG. 5 is a state where a cover 32 is removed and an interior of a housing 34 is seen.

The magnetic disk apparatus 30 illustrated in FIG. 5 has the above-mentioned magnetic disk 10 in the housing 34. The magnetic disk 10 is rotated by a spindle motor 36. A voice coil motor 38 is arranged near the magnetic disk 10. An arm 42 is attached to a pivot 40, which is rotated by the voice coil motor 38, and a suspension 44 is provided to a tip of the arm 42. A magnetic head 46 is attached at a tip of the suspension 44. It is so configured and arranged that the arm 42 moves by driving the voice coil motor 38 and, thereby, the magnetic head 46 moves in a radial direction on the magnetic disk 10. Thus, by moving the magnetic head 46 as mentioned above, the magnetic head 46 can be positioned at a desired track on the magnetic disk 10.

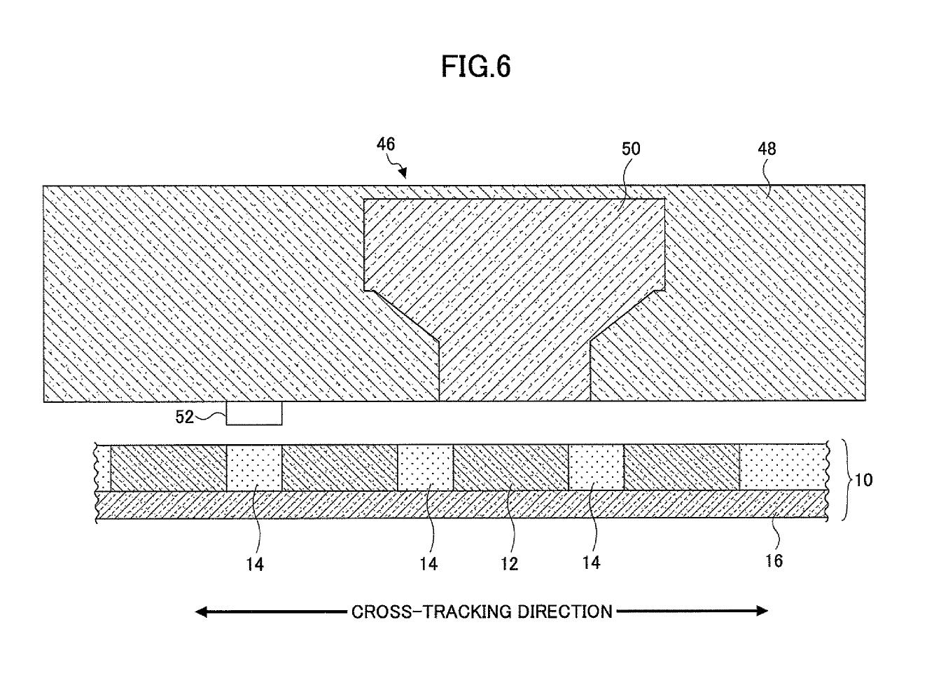

In a general magnetic disk apparatus, a magnetic head is floated above a magnetic disk by an air stream associated with a rotation of the magnetic disk. FIG. 6 is a cross-sectional view of the magnetic disk 10 and the magnetic head 46 floating above the magnetic disk 10. The magnetic head 46 has a structure in which a magnetic recording and reproducing part 50 is provided in a slider 48. The magnetic recording and reproducing part 50 is configured and arranged so that, when floating above the magnetic disk 10, the magnetic recording and reproducing head 50 faces and matches one of the track parts 12 (recording track). FIG. 6 illustrates the state where the magnetic recording and reproducing head 50 is positioned to the track part 12 with good accuracy. The servo information recorded on the non-magnetic area 14 by accumulation of electric charges is used for a position control of the magnetic head 46 for positioning the magnetic recording and reproducing part 50 to the track part 12 with good accuracy.

In order to read the servo information recorded in the non-magnetic area 14, a conductive probe 52 is provided on a surface of the slider 48. The conductive probe 52 is a capacitance sensor for detecting a capacitance due to an electric charge in the non-magnetic area 14. The conductive probe 52 is formed, for example, as an electrode wiring pattern formed on the surface of the slider 48. A value of reading the capacitance corresponding to the electric charge in the non-magnetic area 14 is output from the conductive probe 52.

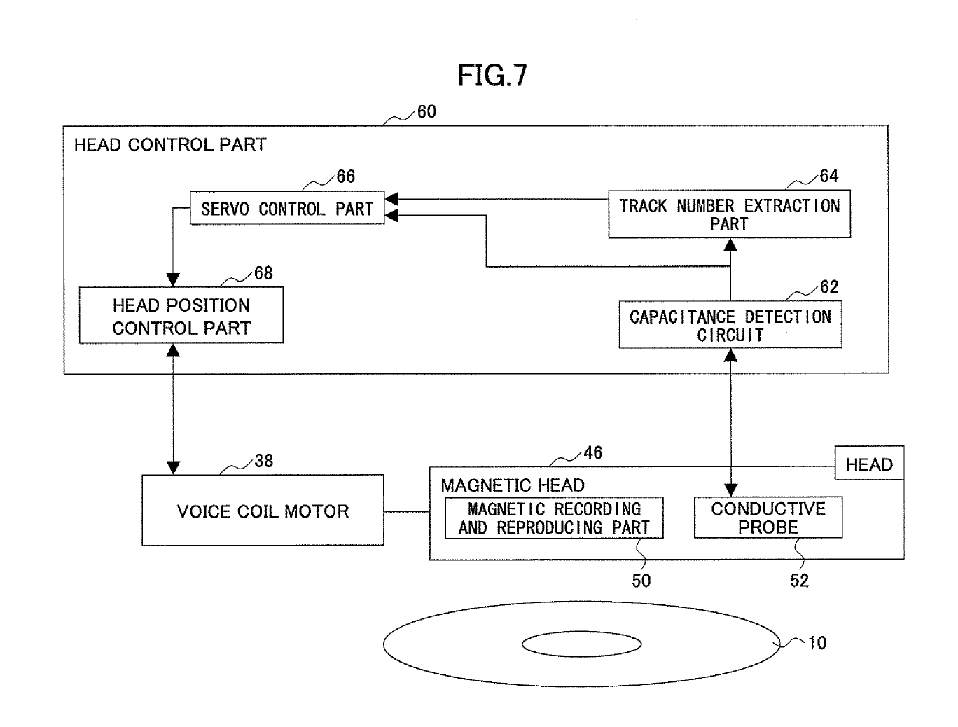

FIG. 7 is a block diagram of a head control part provided in the magnetic disk apparatus 30. The head control part 60 includes a capacitance detection circuit 62, a track number information extraction part 64, a servo control part 66, and a head position control part 68.

The capacitance detection circuit 62 detects a capacitance by an output signal from the conductive probe 52, and supplies a detected signal to the track number information extraction part 64 and the servo control part 66. The track number information extraction part 64 digitally processes the detected signal to acquire a sequence of “1” and “0” as mentioned above, and acquires a track number from numerical information represented by the sequence. The acquired track number is a number for identifying the track to which the magnetic head 46 of the recording and reproducing part 50 is positioned.

In order to cause the track number information supplied from the track number information extraction part 64 to match a target track number, the servo control part 66 acquires a distance by which the magnetic head 46 must be moved, and supplies a control signal for moving the magnetic head 46 by the acquired distance to a head position control part 68. The head position control part 68 drives the voice coil motor 38 based on the control signal to rotate the arm 42, and causes the magnetic head 46 to move in a radial direction of the magnetic head 46. Thereby, the magnetic head 46 moves (seeks) to a position opposite to the target track.

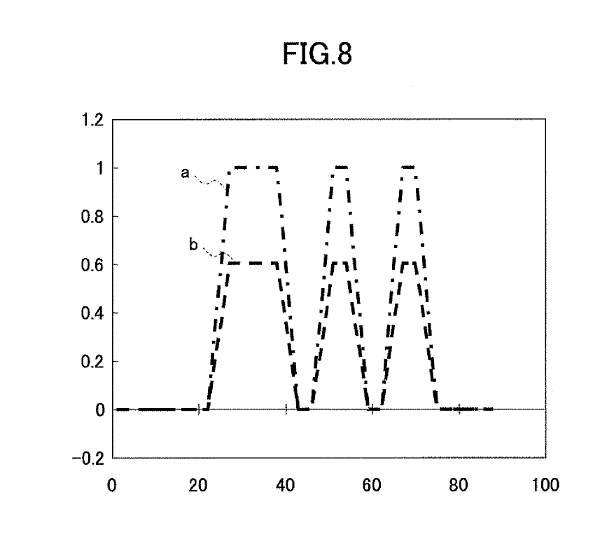

Moreover, the servo control part 66 controls positioning of the magnetic head 46 to the target track based on the detected signal supplied from the track number information extraction part 64. FIG. 8 is a waveform chart of the detected signal supplied from the track number information extraction part 64. An intensity (amplitude of waveform) of the detected signal changes according to a position of the non-magnetic area 14 by which the center of the conductive probe 52 passed.

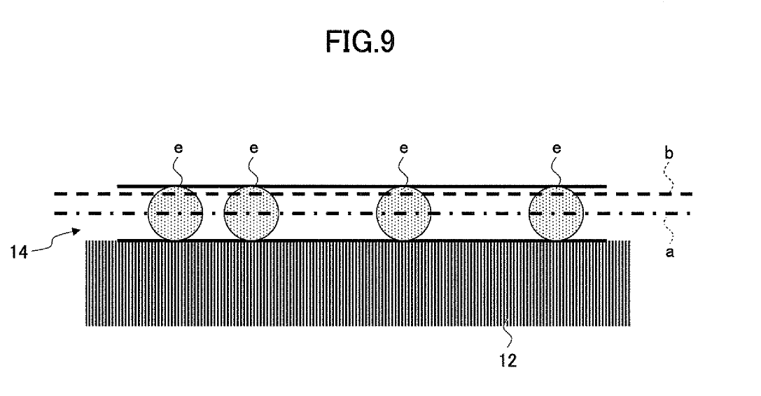

For example, if the center of the conductive probe 52 passed along a single-dashed chain line a in FIG. 9, it becomes a signal having a waveform illustrated in FIG. 8. The single-dashed chain line a in FIG. 9 extends along substantially a center of the dot-like electric charges e in the non-magnetic area 14, and, thus, the capacitance to be detected is large and an amplitude of the waveform is large. On the other hand, if the center of the conductive probe 52 passes along a dashed line b in FIG. 9, it becomes a signal having a waveform illustrated in FIG. 8. The dashed line b in FIG. 9 extends along positions off from the center of the dot-like electric charges e in the non-magnetic area 14, and because the capacitance to be detected is small, an amplitude of the waveform is small.

Information regarding a maximum amplitude of the output waveform when the center of the conductive probe 52 passed along the substantially center of the dot-like electric charges e in the non-magnetic area 14 is given to the servo control part 68. Accordingly, the servo control part 68 generates a control signal for moving the magnetic head 46 so that the amplitude of the detected signal waveform supplied from the track number information extraction part 64 approaches the maximum amplitude, and supplies the control signal to a head minutely moving mechanism 70 of the magnetic head 46.

The head minutely moving mechanism 70 is a drive mechanism for minutely moving the magnetic head 46 in a radial direction of the magnetic disk, and, for example, corresponds to a minutely moving actuator provided between the magnetic head 46 and the suspension 44.

As mentioned above, the magnetic disk apparatus 30 as a magnetic recording apparatus according to the present embodiment can control a seeking operation and a positioning operation of the magnetic head 46 by reading the servo information by the magnetic head 46, which servo information is recorded as electric charges in the non-magnetic area 14 of the magnetic disk 10. Because the servo information is recorded as electric charges in the non-magnetic area 14 of the magnetic disk 10, there is no need to use the user data area of the magnetic disk 10 and the user data area can be used maximally.

In addition, although the magnetic disk 10 according to the present embodiment can be used with the above-mentioned floating type magnetic head, it can also be used with a system in which a magnetic disc is rotated while the magnetic head is not floated and in contact with the magnetic disk. That is, because the surface of the magnetic disk 10 according to the present embodiment is flat and smooth, the slider of the magnetic head can be slid while being brought into contact with the magnetic head 10. In order to detect a capacitance by causing the conductive probe 52 to be close to the electric charges e in the non-magnetic area 14 of the magnetic disk 10 in the present embodiment, it is preferable to use such a contact type magnetic head and magnetic disk. It should be noted that, in this case, the conductive probe 52 is preferably embedded in the slider 48 so that it does not protrude from the surface.

All examples and conditional language recited herein are intended for pedagogical purposes to aid the reader in understanding the principles of the invention and the concepts contributed by the inventor to furthering the art, and are to be construed a being without limitation to such specifically recited examples and conditions, nor does the organization of such examples in the specification relates to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A magnetic recording medium comprising:
a plurality of recording tracks formed of a magnetic material; and
a non-magnetic area arranged between the recording tracks to separate each recording track,
wherein said non-magnetic area is formed of a non-magnetic material, which accumulates and retains electric charges.

2. The magnetic recording medium according to claim 1, wherein said non-magnetic area is a lamination of a silicon layer, a silicon oxide layer, a silicon nitride layer, and a metal layer stacked on a metal substrate in that order.

3. The magnetic recording medium according to claim 1, wherein said non-magnetic area is formed of a ferroelectric material.

4. The magnetic recording medium according to claim 1, wherein the electric charges are accumulated in a dot form in said non-magnetic area.

5. The magnetic recording medium according to claim 4, wherein the electric charges accumulated in a dot form represent track number information for recognizing said recording tracks.

6. The magnetic recording medium according to claim 4, wherein the electric charges accumulated in a dot form represent servo information used for a control to position a magnetic head to said recording tracks.

7. A magnetic recording apparatus comprising:
the magnetic recording medium according to claim 1; and
a magnetic head configured to perform magnetic recording on said recording tracks,
wherein said magnetic head has a conductive probe that detects the electric charges accumulated in said non-magnetic area of said magnetic recording medium.

8. The magnetic recording apparatus according to claim 7, wherein said non-magnetic area is a lamination of a silicon layer, a silicon oxide layer, a silicon nitride layer, and a metal layer stacked on a metal substrate in that order.

9. The magnetic recording apparatus according to claim 7, wherein said non-magnetic area is formed of a ferroelectric material.

10. The magnetic recording apparatus according to claim 7, wherein servo information is recorded by accumulating the electric charges in a dot form in said non-magnetic area of said magnetic recording medium, and the magnetic recording apparatus has a head control part that controls a movement of said magnetic head by extracting the servo information from a detection signal output from said conductive probe.

11. The magnetic recording apparatus according to claim 10, wherein said head control part has a track number extraction part configured to extract track number information for recognizing said recording tracks from the servo information represented by said electric charges accumulated in a dot form.

12. The magnetic recording apparatus according to claim 10, wherein said head control part has a servo control part configured to create a control signal for controlling an operation to position said magnetic head to said recording tracks based on a detection value of detection of said electric charges accumulated in a dot form.

13. The magnetic recording apparatus according to claim 7, wherein said magnetic head performs a magnetic recording and reproduction while contacting said magnetic recording medium.
